(19) United States
(12) Patent Application Publication
(10) Pub. No.: US 2024/0096115 A1
(43) Pub. Date: Mar. 21, 2024

(54) LANDMARK DETECTION WITH AN ITERATIVE NEURAL NETWORK

(71) Applicant: NVIDIA Corporation, Santa Clara, CA (US)

(72) Inventors: Pavlo Molchanov, Mountain View, CA (US); Jan Kautz, Lexington, MA (US); Arash Vahdat, San Mateo, CA (US); Hongxu Yin, San Jose, CA (US); Paul Micaelli, Edinburgh (GB)

(21) Appl. No.: 18/243,555

(22) Filed: Sep. 7, 2023

Related U.S. Application Data
(60) Provisional application No. 63/406,175, filed on Sep. 13, 2022.

(51) Int. Cl. G06V 20/59; G06T 7/70; G06V 10/82; G06V 20/70; G06V 40/16

(52) U.S. Cl. CPC G06V 20/597; G06T 7/70; G06V 10/82; G06V 20/70; G06V 40/171; G06T 2207/30201; G06V 2201/07

(57) ABSTRACT

Landmark detection refers to the detection of landmarks within an image or a video, and is used in many computer vision tasks such emotion recognition, face identity verification, hand tracking, gesture recognition, and eye gaze tracking. Current landmark detection methods rely on a cascaded computation through cascaded networks or an ensemble of multiple models, which starts with an initial guess of the landmarks and iteratively produces corrected landmarks which match the input more finely. However, the iterations required by current methods typically increase the training memory cost linearly, and do not have an obvious stopping criteria. Moreover, these methods tend to exhibit jitter in landmark detection results for video. The present disclosure improves current landmark detection methods by providing landmark detection using an iterative neural network. Furthermore, when detecting landmarks in video, the present disclosure provides for a reduction in jitter due to reuse of previous hidden states from previous frames.

### RELATED APPLICATION(S)

This application claims the benefit of U.S. Provisional Application No. 63/406,175 (Attorney Docket No. NVIDP1360+/22-SC-1264US01), titled “LANDMARK ESTIMATION USING A DEEP EQUILIBRIUM MODEL” and filed Sep. 13, 2022, the entire contents of which is incorporated herein by reference.

### TECHNICAL FIELD

The present disclosure relates to landmark detection processes.

### BACKGROUND

Landmark detection, sometimes also referred to as landmark estimation, refers to the detection of landmarks within an image or a video. Landmark detection is a central step when solving many complex computer vision problems, such as emotion recognition, face identity verification, hand tracking, gesture recognition, and eye gaze tracking. Reliable landmark detection can simplify solutions to these problems and is often part of the pipeline for sophisticated, robust computer vision tools.

Early solutions, to facial landmark detection in particular, relied on a statistical model of the global face appearance and shape, but these early solutions were eventually superseded by deep learning regression models. Both traditional and modern approaches have relied upon cascaded computation, which starts with an initial guess of the landmarks and iteratively produces corrected landmarks which match the input more finely. This cascaded computation has typically been provided using cascaded networks or an ensemble of multiple models.

However, the iterations required by current methods typically increase the training memory cost linearly, and do not have an obvious stopping criteria. Moreover, when performing landmark detection in video, current methods tend to produce jitter (uncertainty that results in quick chaotic keypoint movement between two consecutive frames).

There is a need for addressing these issues and/or other issues associated with the prior art. For example, there is a need to provide landmark detection using an iterative neural network.

### SUMMARY

A method, computer readable medium, and system are disclosed for landmark detection using an iterative neural network. An input is processed, using an iterative neural network, to predict one or more landmarks for the input. The one or more landmarks are then output.

### BRIEF DESCRIPTION OF THE DRAWINGS

FIG. 1 illustrates a method for landmark detection using an iterative neural network, in accordance with an embodiment.

FIG. 2 illustrates a system for detecting landmarks for an input using an iterative neural network, in accordance with an embodiment.

FIG. 3 illustrates a pipeline of the iterative neural network in the system of FIG. 2, in accordance with an embodiment.

FIG. 4 illustrates a pipeline of the iterative neural network in the system of FIG. 2, in accordance with an embodiment.

FIG. 5 illustrates a method for processing detected landmarks by a downstream computer vision task, in accordance with an embodiment.

FIG. 6A illustrates inference and/or training logic, according to at least one embodiment;

FIG. 6B illustrates inference and/or training logic, according to at least one embodiment;

FIG. 7 illustrates training and deployment of a neural network, according to at least one embodiment;

FIG. 8 illustrates an example data center system, according to at least one embodiment.

### DETAILED DESCRIPTION

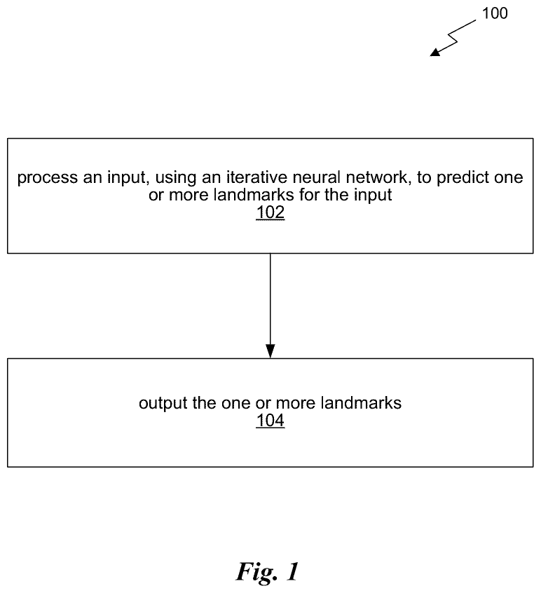

FIG. 1 illustrates a method 100 for landmark detection using an iterative neural network, in accordance with an embodiment. The method 100 may be performed by a device, which may be comprised of a processing unit, a program, custom circuitry, or a combination thereof, in an embodiment. In another embodiment a system comprised of a non-transitory memory storage comprising instructions, and one or more processors in communication with the memory, may execute the instructions to perform the method 100. In another embodiment, a non-transitory computer-readable media may store computer instructions which when executed by one or more processors of a device cause the device to perform the method 100.

In operation 102, an input is processed, using an iterative neural network, to predict one or more landmarks for the input. With respect to the present description, the input refers to data representative of at least one object or a scene on which one or more landmarks are capable of being predicted by the iterative neural network. In an embodiment, the input may be an image. In another embodiment, the input may be a plurality of images. In yet another embodiment, the input may be a video (i.e. comprised of a plurality of video frames).

As mentioned, the input is representative of (e.g. depicts) some object(s) or scene on which one or more landmarks are capable of being predicted by the iterative neural network. Accordingly, the input may be an image of an object, and the landmarks may be located on the object. In various embodiments, the object may be a human face, body, hand, etc., or any animal or static object (e.g. table, chair, etc.). For example, the input may depict a human face. In this example, the landmark(s) may include facial landmarks (e.g. eyes, nose, mouth, etc.). In another example, the input may depict a scene of an environment. With respect to this example, the landmark(s) may include points of interest, or points having some defined significance, within the scene (e.g. buildings, persons, cars, etc.). Of course, the types (e.g. categories, classes, etc.) of landmarks that are detected may be preconfigured for the iterative neural network.

The iterative neural network that processes the input to predict the landmark(s) refers to a neural network that employs iterative learning to predict landmarks for a given input. In an embodiment, the iterative neural network may be a deep equilibrium model (DEQ). In an embodiment, the iterative neural network may include a recurrent loss term.

In an embodiment, the iterative neural network may process the input over a plurality of iterations. In an embodiment, the iterative neural network may process the input over the plurality of iterations until an equilibrium is found. Accordingly, in an embodiment, a number of iterations employed by the iterative neural network may be dynamic, per the given input (i.e. until the equilibrium is found for the input), as opposed to the iterative neural network being statically configured with a particular number of iterations.

In an embodiment, the iterative neural network may be trained on labeled still images. As described above, the trained iterative neural network may then process an input image to predict the landmark(s) for the input image. However, in another embodiment, even when the iterative neural network is trained on the labeled still images, the trained iterative neural network may process an input video having a plurality of frames to predict the landmark(s) for each of the frames.

In an embodiment, a plurality of videos may be labeled. In this case, for example, each video may be labeled by utilizing a plurality of existing (and independent) trained neural networks to independently predict labels for the video, and further labeling the video based on statistics of the predicted labels from the plurality of existing trained neural networks. The plurality of existing trained neural networks may be trained on still images or on videos. The statistics may include a mean of the predicted labels, in an embodiment.

Returning to the processing performed by the iterative neural network, in an embodiment the iterative neural network may predict each of the landmarks via a corresponding heatmap. In an embodiment, the heatmap may be converted into a landmark point representing the corresponding landmark. In an embodiment, an initial iteration (e.g. of the processing by the iterative neural network) may generate at least one initial heatmap for the input, and then each subsequent iteration may update a heatmap (or each heatmap in the case of multiple heatmaps) from a prior iteration. In a further embodiment, each initial heatmap may correspond to a landmark to be learned. In other embodiments, other latent (or hidden) representations other than a heatmap may similarly be used for predicting the landmarks.

Still yet, in an embodiment where the input is video, the iterative neural network may be configured to provide temporal coherence of predicted landmarks across sequential frames of the video. In an embodiment, the iterative neural network may process the plurality of frames to predict the one or more landmarks for each frame of the plurality of frames, whereby for each frame after an initial frame of the video, the iterative neural network may process a landmark prediction made by the iterative neural network for a prior frame of the video, to predict the one or more landmarks for the frame. Further to this embodiment, for the initial frame, the iterative neural network may process an initialized landmark prediction to predict the one or more landmarks for the initial frame. In an embodiment, the initialized landmark prediction may be set to zero. By processing the landmark prediction made by the iterative neural network for the prior frame of the video when processing a current frame of the video, temporal coherence of predicted landmarks across sequential frames of the video may be provided by the iterative neural network.

In another embodiment where the input is video, a number of steps that the iterative neural network takes when processing each frame (after the initial frame of the video) may be limited based on a predefined criterion. The predefined criterion may include a threshold difference between outputs of sequential steps, in one embodiment. For example, during processing of a frame by the iterative neural network, the iterative neural network may terminate such processing when the difference between outputs of sequential steps is less than a defined threshold.

In operation 104, the one or more landmarks are then output. The landmark(s) may be output for any desired purpose. In an embodiment, the landmark(s) predicted for the input may be output to a downstream task. The downstream task may be a computer vision task, in an embodiment.

In one example, the downstream task includes a self-driving application. With respect to this self-driving application example, the input may depict a human face of a driver of an automobile, and the self-driving application may use the landmark(s) predicted for the human face to monitor a state of the driver of the automobile for making autonomous driving policy decisions based thereon. In another example, the downstream task may include an avatar-based application. With respect to this avatar-based application example, the input may depict a human face and the avatar-based application may use the landmark(s) predicted for the human face to apply a select avatar to the depiction of the human face. In yet another example, the avatar-based application may use landmark(s) predicted for an input human body to determine a pose of the human body and to generate the avatar in the pose.

Further embodiments will now be provided in the description of the subsequent figures. It should be noted that the embodiments disclosed herein with reference to the method 100 of FIG. 1 may apply to and/or be used in combination with any of the embodiments of the remaining figures below. It should be noted that the synthetic dataset generated in accordance with the method 100 may be referred to in the descriptions below as an output synthetic dataset, in order to differentiate such synthetic dataset from the input synthetic dataset mentioned above and elsewhere in the disclosed embodiments.

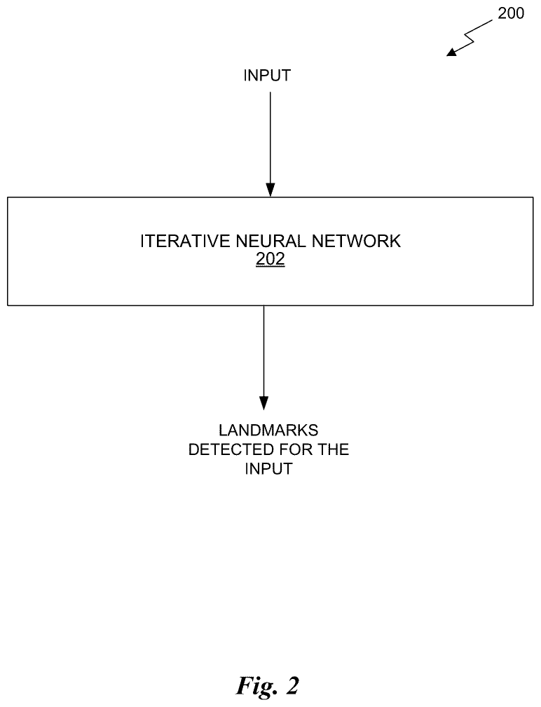

FIG. 2 illustrates a system 200 for detecting landmarks in an image using an iterative neural network, in accordance with an embodiment. The system 200 may be implemented to perform the method 100 of FIG. 1, in an embodiment. Of course, however, the system 200 may be implemented in any desired context. The definitions and embodiments described above may equally apply to the description of the present embodiment.

As shown, input is provided to an iterative neural network 202. The iterative neural network 202 executes on a computing device (e.g. server). In an embodiment, the iterative neural network 202 may execute in a cloud. The iterative neural network 202 is trained to detect landmarks for a given input, as described in more detail below.

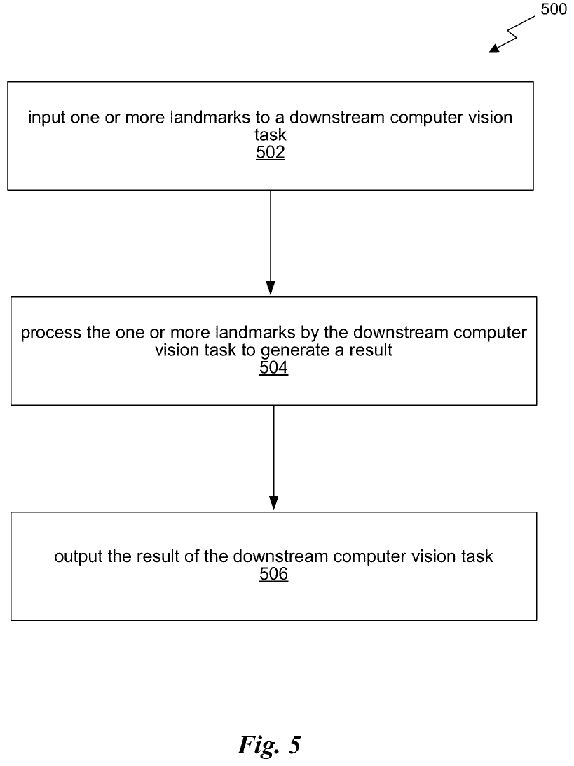

The input may be received from an application. The application may be configured to use the input to perform a downstream task (described in further detail below with reference to FIG. 5). In an embodiment, the application may execute on the same computing device on which the iterative neural network 202 executes. In another embodiment, the application may execute on a remote computing device, such that the iterative neural network 202 may receive the input from the application via a network.

The iterative neural network 202 processes the input to detect one or more landmarks for the input. The iterative neural network 202 outputs the landmarks detected for the input. The iterative neural network 202 may output the landmarks to the application, in an embodiment. For example, the application may then use the landmarks to perform a particular downstream task that requires the landmarks as input.

Iterative Neural Network Training—an Embodiment

Consider learning a landmark detection model (iterative neural network 202) F parameterized by θ, which maps an input image x to landmarks z. Instead of directly having z as 2D landmarks, z can represent L heatmaps of size D×D, where D is a hyperparameter (e.g. 64) and L is the number of landmarks to learn. While typical machine learning models can explicitly write down the function z=F(x; θ), in the iterative neural network 202 approach this function is expressed implicitly by requiring its output to be a fixed point of another function ƒ(z, x; θ), as illustrated in Equation 1.

F:x→z*s.t. z*=ƒ(z*,x;θ) Equation 1
where z* denotes the fixed point, or equivalently the root of g(x, z; θ)=ƒ(z, x; θ)−z. The function ƒ must have inputs and outputs of similar shape. In an embodiment, ƒ is built from the ubiquitous hourglass module h (similar to a Unet), per Equation 2.

ƒ(z*,x;θ)=α([x,z];θ)) Equation 2
where h inputs the concatenation of x and z, and a is a normalization function. For clarity, we omit from our notation that image x is downsampled, in an embodiment, with a few convolutions to match the shape of z.

To evaluate ƒ in the forward pass, we must solve for its fixed point z*. When ƒ is a contraction mapping, ƒ∘ƒ∘ƒ∘ . . . ∘ƒ∘z⁽⁰⁾ converges to a unique z* for any initial heatmap z⁽⁰⁾. We use z⁽⁰⁾=0 when training the iterative neural network 202 on still images.

In the iterative neural network 202, a normalization of the heatmaps to [0, 1] at each refining stage is used, per Equation 3.

$$σ ( z ) = exp ( \frac{z - max ( z )}{T} ) \qquad Equation 3$$

where T is a temperature hyperparameter. This layer also acts as an entropy regularizer, since it induces low-entropy (“peaked”) heatmaps, to improve convergence of root solvers.

The iterative neural network 202 uses a single hourglass module which updates z until an equilibrium is found. The last predicted heatmaps, z*, are converted into 2D landmark points \hat{p}=Φ(z*) using the softargmax function (D(z). These points are trained to match the ground truth p, and so the iterative neural network 202 landmark training problem can be seen as a constrained optimization, per Equation 4.

$$\begin{matrix}{θ}^{*} = \begin{matrix}arg min \\ θ\end{matrix} {ℒ}_{M S E} ( Φ ( {z}^{*} ) , p ) \\ s . t . {z}^{*} = f ( {z}^{*} , x ; θ )\end{matrix} \qquad Equation 4$$

To differentiate the loss function [symbol] _{MSE} through this root solving process, the implicit function theorem is used to derive Equation 5.

$$\frac{\partial {ℒ}_{M S E}}{\partial θ} = \frac{\partial {ℒ}_{M S E}}{\partial {z}^{*}} {𝒥}_{g {z}^{*}}^{- 1} \frac{\partial f ( {z}^{*} , x ; θ )}{\partial θ} \qquad Equation 5$$

where the first two terms on the right hand side can be expressed as the solution to a fixed point problem as well. Solving for this root in the backward pass means that it is not necessary to compute or store the expensive inverse Jacobian term [symbol] _{gz*}⁻¹ directly. Importantly, this backward-pass computation only depends on z* and doesn't depend on the operations done in the forward pass to reach an equilibrium. This means that these operations do not need to be tracked by autograd, and therefore that training requires a memory cost of O(1), despite differentiating through a potentially infinite recurrence.

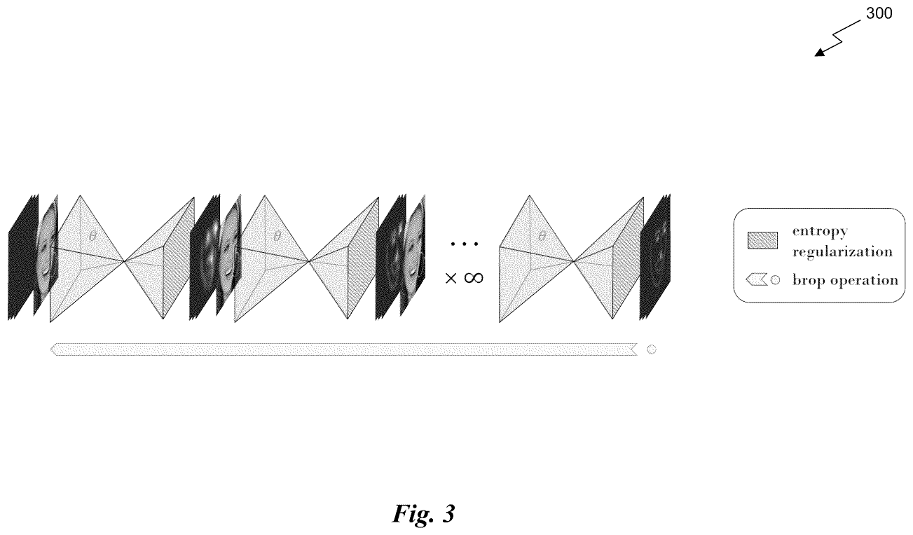

FIG. 3 illustrates a pipeline 300 of the iterative neural network 202 in the system 200 of FIG. 2, in accordance with an embodiment. The pipeline 300 is just one exemplary implementation of the iterative neural network 202.

As mentioned above, the iterative neural network 202 may include a single (e.g. hourglass) module. In an embodiment, the module updates one or more heatmaps (generated for a given input) over a number of stages until a stopping point (e.g. equilibrium) is found. The last predicted heatmaps are then converted to landmark points. Of course it should be noted that in other embodiments the model may estimate a latent (or hidden) representation other than a heatmap.

This pipeline 300 for the iterative neural network 202 incurs a constant memory cost with a dynamic number of refining stages. As mentioned above, at each stage the landmark probability heatmaps are computed, and convergence to an equilibrium is encouraged by lowering their entropy. The iterative neural network 202 can directly solve for an infinite number of refinement stages at a constant memory cost and without gradient degradation. This is done by relying on the implicit function theorem, as opposed to tracking each forward operation in autograd. Furthermore, the iterative neural network 202 naturally supports adaptive compute, in the sense that the number of cascaded stages will be determined by how hard finding an equilibrium is for a specific input.

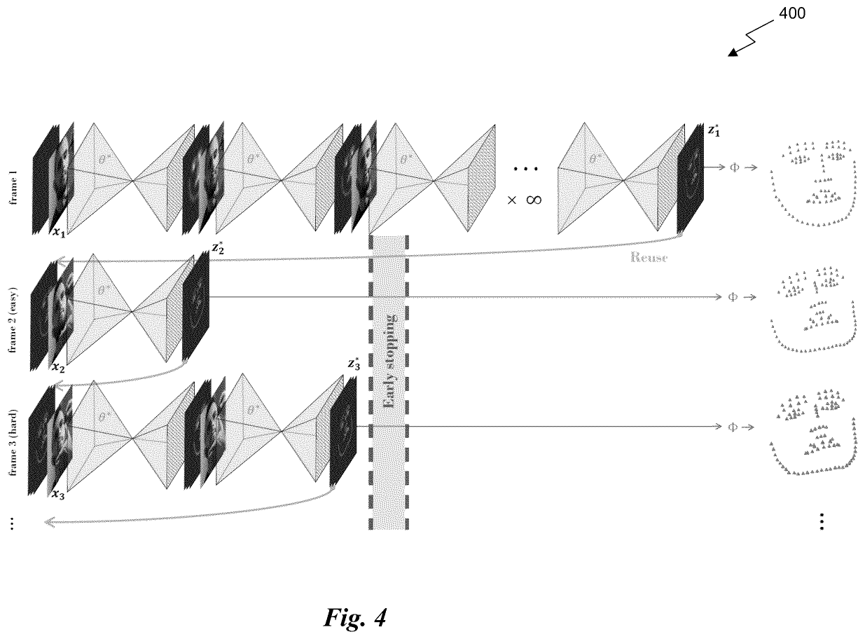

FIG. 4 illustrates a pipeline 400 of the iterative neural network 202 in the system 200 of FIG. 2, in accordance with an embodiment. The pipeline 400 is another exemplary implementation of the iterative neural network 202.

In the present embodiment, the iterative neural network 202 employs recurrence at test time, without recurrence having been required at training time. In particular, the iterative neural network 202, one trained, can allow for some additional objective at inference time. This new objective is used to disambiguate which fixed point of ƒ(z, x; θ*) is found, in light of extra information present at test time.

The pipeline 400 shown in the present embodiment illustrates the iterative neural network 202, that is trained on still images, being employed at inference time to detect landmarks in video. An initialization heatmap zₙ⁰ is used when processing the first frame, and then zₙ⁰=zₙ₋₁* for n>1 is used for each subsequent frame. Combined with early stopping, this is equivalent to regularizing the fixed point zₙ so that it is more temporally coherent with all its predecessors.

One exemplary implementation, as provided below, describes the specific application of training the iterative neural network 202 on face images and evaluating it on videos. In this case, the iterative neural network 202 allows a recurrent loss term to be included at inference time.

Let ƒ(z, x; θ*) be the iterative neural network 202 trained as per the formulation in Equation 4. To do inference on a video of N frames x₁, x₂, . . . , x_{N}, consider that a given frame xₙ has a corresponding set of fixed points [symbol] ₙ*={z s. t. ƒ(z, xₙ; θ*)=z}, representing plausible landmark heatmaps. If we select some zₙ*∈ [symbol] ₙ* at random for each frame n, the corresponding heatmaps z₁*, z₂*, . . . , z_{N}* often exhibit some flickering artifacts, whereby landmarks rapidly change across contiguous frames. To address this issue, the fixed point at frame n that is closest to the fixed point at frame n−1 is chosen. This can be expressed by the constrained optimization in Equation 6A and 6B.

zₙ*=arg min∥z−zₙ₋₁*∥₂² Equation 6A

s.t. ƒ(z,xₙ;θ*)=z Equation 6B

The problem above is equivalent to solving for the saddle point of a Lagrangian as per Equation 7.

$$\begin{matrix}min \\ z\end{matrix} \begin{matrix}max \\ λ\end{matrix} {‖ z - {z}_{n - 1}^{*} ‖}_{2}^{2} + {λ}^{T} f ( z , {x}_{n} ; {θ}^{*} ) - z ) \qquad Equation 7$$

where λ are Lagrange multipliers. Effectively, the set of fixed points [symbol] ₙ* in Equation 6B are used as the trust region for the objective in Equation 6A. In practice, adversarial optimization is notoriously unstable, as is typically observed in the context of GANs. Furthermore, this objective breaks down if [symbol] ₙ*=Ø for any xₙ. Both of these problems are remedied by relaxing the inference time optimization problem using Equation 8.

$$\begin{matrix}min \\ z\end{matrix} {‖ f ( z , {x}_{n} ; {θ}^{*} ) - z ‖}_{2}^{2} + \frac{α}{2} {‖ z - {z}_{n - 1}^{*} ‖}_{2}^{2} \qquad Equation 8$$

where α is a hyperparameter that trades off fixed-point solver error versus the shift in heatmaps across two consecutive frames. This objective can be more readily tackled with Newtonian optimizers.

Converting the root solving problem into an optimization problem during the forward pass of each frame can significantly increase inference time. However, the objective in Equation 8 can also be solved by using root solvers. First, note that it is equivalent to finding the MAP estimate given a log likelihood and prior, per Equations 9A and 9B.

log p(xₙ|z;θ*)∝−∥ƒ(z,xₙ;θ*)−z∥₂² Equation 9A

p(z)= [symbol] (z;zₙ₋₁,α⁻¹ [symbol] Equation 9B

This prior, when centered on the initialization to a search algorithm, can be implemented by early stopping this algorithm. As such, the solution to Equations 6A and 6B can be approximated by simply initializing the root solver with zₙ⁰=zₙ₋₁* (“reuse”) and imposing a hard limit on the number of steps that it can take (“early stopping”).

Video Landmark Coherence

In an embodiment described herein, a normalized mean flicker (NMF) metric can be used by the iterative neural network 202 to measure the amount of temporal coherence in landmark videos. In an embodiment also described herein, a new landmark video dataset may be created to train the iterative neural network 202.

NFM: A Metric to Track Temporal Coherence

The performance of a landmark detection model is typically measured with a single metric called the Normalized Mean Error (NME). Consider a video sequence of N frames, each containing L ground truth landmarks. A single landmark point is a 2D vector denoted p_{n,l}∈R², where n and l are the frame and landmark index respectively. Let r_{n,l}=p_{n,l}−\hat{p}_{n,l} be the residual vector between ground truth landmarks and predicted landmarks \hat{p}_{n,l}. The NME simply averages the [symbol] ₂ norm of this residual across all landmarks and all frames, per Equations 10A and 10B.

$${NME}_{n} = \frac{1}{L} {\sum }_{l = 1}^{L} \frac{‖ {r}_{n , l} ‖}{{d}_{0}} \qquad Equation 10 A$$

$$NME = \frac{1}{N} {\sum }_{n = 1}^{N} {NME}_{n} \qquad Equation 10 B$$

Here d₀ is usually the inter-ocular distance, and aims to make the NME better correlate with the human perception of landmark error. However, this metric alone is insufficient to measure the performance of a landmark detector in videos. For example, while two models may have equal NME, they may also have different coherence in time, with one model exhibiting flickering between plausible hypotheses when uncertain. This flickering is a nuisance for many applications, and yet is not captured by the NME. This is in contrast to random noise (jitter) which is unstructured and already reflected in the NME metric.

To measure temporal coherence, a new NMF metric is provided. This metric is designed to be orthogonal to the NME, by making it agnostic to the magnitude of r_{n,l}, and only focusing on the change of r_{n,l} across consecutive frames, per Equations 11A and 11B.

$${NMF}_{n} = \sqrt{\frac{1}{L} {\sum }_{l = 1}^{L} \frac{{‖ {r}_{n , l} - {r}_{n - 1 , l} ‖}^{2}}{{d}_{1}^{2}}} \qquad Equation 11 A$$

$$NMF = \sqrt{\frac{1}{N} {\sum }_{n = 2}^{F} N M {F}_{n}^{2}} \qquad Equation 11 B$$

We replace the means in the NME with a root mean square to better represent the human perception of flicker. Indeed, this penalizes a short sudden changes in r_{n,l} compared to the same change smoothed out in time and space. The value di is chosen to be the face area. This prevents a long term issue with the NME score, namely the fact that large poses can have an artificially large NME due to having a small do.

Landmark Video Dataset

Due to the tedious nature of producing landmark annotations for video data, there are few existing datasets for face landmark detection in videos. The present description provides for a new video dataset for facial landmarks. In an embodiment, it consists of publicly available videos that are collected and then labeled in an automated manner. In particular, existing trained neural networks are used to independently predict labels for each video, and then the video is labeled based on statistics (e.g. an average) of the predicted labels. In an embodiment, uncertain models may be given less weight in the aggregated output.

FIG. 5 illustrates a method 500 for processing detected landmarks by a downstream computer vision task, in accordance with an embodiment. The method 500 may be performed in the context of any of the embodiments described herein. The definitions and embodiments described above may equally apply to the description of the present embodiment.

In operation 502, one or more landmarks are input to a downstream computer vision task. The landmark(s) refer to those predicted using the iterative neural network 202 of FIG. 2. For example, the landmark(s) may be predicted for an image or a video.

In operation 504, the landmark(s) are processed by the downstream computer vision task to generate a result. In one embodiment, the downstream computer vision task may be a self-driving application. With respect to this self-driving application example, the landmark(s) may be those predicted for a face of a person driving a vehicle. The self-driving application may use the landmark(s) predicted for the person's face to monitor a state of the driver of the automobile. The self-driving application may then make autonomous driving policy decisions based on the state of the driver of the automobile, such as initiating autonomous driving of the vehicle when the state of the driver indicates that the driver is distracted or otherwise not safely focused on driving of the vehicle.

In another example, the downstream computer vision task may be an avatar-based application. With respect to this avatar-based application example, the landmark(s) may be those predicted for a face and/or body. The avatar-based application may use the landmark(s) predicted for the human face to apply a select avatar to the depiction of the human face. In yet another example, the avatar-based application may use the landmark(s) predicted for the human body to determine a pose of the human body and to generate the avatar in the pose.

In operation 506, the result of the downstream computer vision task is output. In an embodiment, the result of the downstream computer vision task may be output to an anonymous driving control system, for example in the case that the downstream computer vision task is the self-driving application. In another embodiment, the result of the downstream computer vision task may be output (i.e. rendered) to a display, for example in the case that the downstream computer vision task is the avatar-based application.

### Machine Learning

Deep neural networks (DNNs), including deep learning models, developed on processors have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions. Inferencing is less compute-intensive than training, being a latency-sensitive process where a trained neural network is applied to new inputs it has not seen before to classify images, translate speech, and generally infer new information.

### Inference and Training Logic

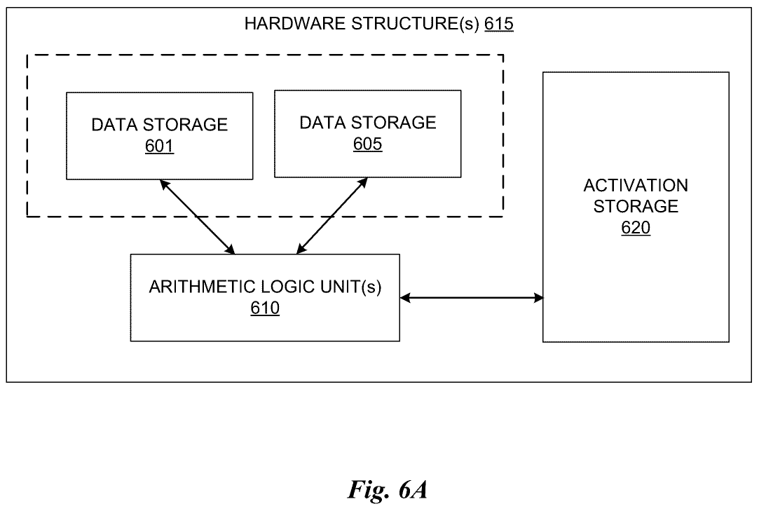

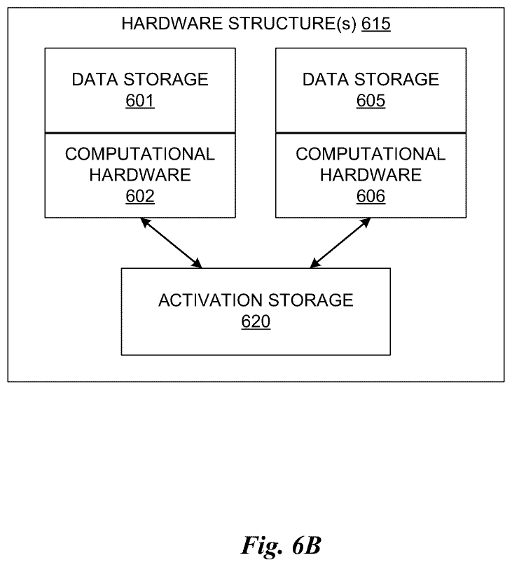

As noted above, a deep learning or neural learning system needs to be trained to generate inferences from input data. Details regarding inference and/or training logic 615 for a deep learning or neural learning system are provided below in conjunction with FIGS. 6A and/or 6B.

In at least one embodiment, inference and/or training logic 615 may include, without limitation, a data storage 601 to store forward and/or output weight and/or input/output data corresponding to neurons or layers of a neural network trained and/or used for inferencing in aspects of one or more embodiments. In at least one embodiment data storage 601 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of data storage 601 may be included with other on-chip or off-chip data storage, including a processor's L1, L2, or L3 cache or system memory.

In at least one embodiment, any portion of data storage 601 may be internal or external to one or more processors or other hardware logic devices or circuits. In at least one embodiment, data storage 601 may be cache memory, dynamic randomly addressable memory (“DRAM”), static randomly addressable memory (“SRAM”), non-volatile memory (e.g., Flash memory), or other storage. In at least one embodiment, choice of whether data storage 601 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 615 may include, without limitation, a data storage 605 to store backward and/or output weight and/or input/output data corresponding to neurons or layers of a neural network trained and/or used for inferencing in aspects of one or more embodiments. In at least one embodiment, data storage 605 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, any portion of data storage 605 may be included with other on-chip or off-chip data storage, including a processor's L1, L2, or L3 cache or system memory. In at least one embodiment, any portion of data storage 605 may be internal or external to on one or more processors or other hardware logic devices or circuits. In at least one embodiment, data storage 605 may be cache memory, DRAM, SRAM, non-volatile memory (e.g., Flash memory), or other storage. In at least one embodiment, choice of whether data storage 605 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, data storage 601 and data storage 605 may be separate storage structures. In at least one embodiment, data storage 601 and data storage 605 may be same storage structure. In at least one embodiment, data storage 601 and data storage 605 may be partially same storage structure and partially separate storage structures. In at least one embodiment, any portion of data storage 601 and data storage 605 may be included with other on-chip or off-chip data storage, including a processor's L1, L2, or L3 cache or system memory.

In at least one embodiment, inference and/or training logic 615 may include, without limitation, one or more arithmetic logic unit(s) (“ALU(s)”) 610 to perform logical and/or mathematical operations based, at least in part on, or indicated by, training and/or inference code, result of which may result in activations (e.g., output values from layers or neurons within a neural network) stored in an activation storage 620 that are functions of input/output and/or weight parameter data stored in data storage 601 and/or data storage 605. In at least one embodiment, activations stored in activation storage 620 are generated according to linear algebraic and or matrix-based mathematics performed by ALU(s) 610 in response to performing instructions or other code, wherein weight values stored in data storage 605 and/or data 601 are used as operands along with other values, such as bias values, gradient information, momentum values, or other parameters or hyperparameters, any or all of which may be stored in data storage 605 or data storage 601 or another storage on or off-chip. In at least one embodiment, ALU(s) 610 are included within one or more processors or other hardware logic devices or circuits, whereas in another embodiment, ALU(s) 610 may be external to a processor or other hardware logic device or circuit that uses them (e.g., a co-processor). In at least one embodiment, ALUs 610 may be included within a processor's execution units or otherwise within a bank of ALUs accessible by a processor's execution units either within same processor or distributed between different processors of different types (e.g., central processing units, graphics processing units, fixed function units, etc.). In at least one embodiment, data storage 601, data storage 605, and activation storage 620 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 620 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 620 may be cache memory, DRAM, SRAM, non-volatile memory (e.g., Flash memory), or other storage. In at least one embodiment, activation storage 620 may be completely or partially within or external to one or more processors or other logical circuits. In at least one embodiment, choice of whether activation storage 620 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 615 illustrated in FIG. 6A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 615 illustrated in FIG. 6A may be used in conjunction with central processing unit (“CPU”) hardware, graphics processing unit (“GPU”) hardware or other hardware, such as field programmable gate arrays (“FPGAs”).

FIG. 6B illustrates inference and/or training logic 615, according to at least one embodiment. In at least one embodiment, inference and/or training logic 615 may include, without limitation, hardware logic in which computational resources are dedicated or otherwise exclusively used in conjunction with weight values or other information corresponding to one or more layers of neurons within a neural network. In at least one embodiment, inference and/or training logic 615 illustrated in FIG. 6B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 615 illustrated in FIG. 6B may be used in conjunction with central processing unit (CPU) hardware, graphics processing unit (GPU) hardware or other hardware, such as field programmable gate arrays (FPGAs). In at least one embodiment, inference and/or training logic 615 includes, without limitation, data storage 601 and data storage 605, which may be used to store weight values and/or other information, including bias values, gradient information, momentum values, and/or other parameter or hyperparameter information. In at least one embodiment illustrated in FIG. 6B, each of data storage 601 and data storage 605 is associated with a dedicated computational resource, such as computational hardware 602 and computational hardware 606, respectively. In at least one embodiment, each of computational hardware 606 comprises one or more ALUs that perform mathematical functions, such as linear algebraic functions, only on information stored in data storage 601 and data storage 605, respectively, result of which is stored in activation storage 620.

In at least one embodiment, each of data storage 601 and 605 and corresponding computational hardware 602 and 606, respectively, correspond to different layers of a neural network, such that resulting activation from one “storage/computational pair 601/602” of data storage 601 and computational hardware 602 is provided as an input to next “storage/computational pair 605/606” of data storage 605 and computational hardware 606, in order to mirror conceptual organization of a neural network. In at least one embodiment, each of storage/computational pairs 601/602 and 605/606 may correspond to more than one neural network layer. In at least one embodiment, additional storage/computation pairs (not shown) subsequent to or in parallel with storage computation pairs 601/602 and 605/606 may be included in inference and/or training logic 615.

### Neural Network Training and Deployment

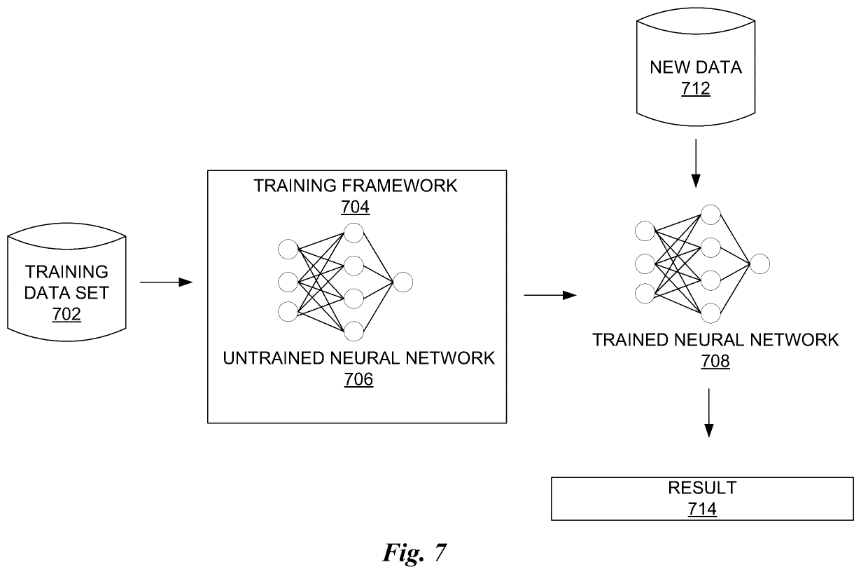

FIG. 7 illustrates another embodiment for training and deployment of a deep neural network. In at least one embodiment, untrained neural network 706 is trained using a training dataset 702. In at least one embodiment, training framework 704 is a PyTorch framework, whereas in other embodiments, training framework 704 is a Tensorflow, Boost, Caffe, Microsoft Cognitive Toolkit/CNTK, MXNet, Chainer, Keras, Deeplearning4j, or other training framework. In at least one embodiment training framework 704 trains an untrained neural network 706 and enables it to be trained using processing resources described herein to generate a trained neural network 708. In at least one embodiment, weights may be chosen randomly or by pre-training using a deep belief network. In at least one embodiment, training may be performed in either a supervised, partially supervised, or unsupervised manner.

In at least one embodiment, untrained neural network 706 is trained using supervised learning, wherein training dataset 702 includes an input paired with a desired output for an input, or where training dataset 702 includes input having known output and the output of the neural network is manually graded. In at least one embodiment, untrained neural network 706 is trained in a supervised manner processes inputs from training dataset 702 and compares resulting outputs against a set of expected or desired outputs. In at least one embodiment, errors are then propagated back through untrained neural network 706. In at least one embodiment, training framework 704 adjusts weights that control untrained neural network 706. In at least one embodiment, training framework 704 includes tools to monitor how well untrained neural network 706 is converging towards a model, such as trained neural network 708, suitable to generating correct answers, such as in result 714, based on known input data, such as new data 712. In at least one embodiment, training framework 704 trains untrained neural network 706 repeatedly while adjust weights to refine an output of untrained neural network 706 using a loss function and adjustment algorithm, such as stochastic gradient descent. In at least one embodiment, training framework 704 trains untrained neural network 706 until untrained neural network 706 achieves a desired accuracy. In at least one embodiment, trained neural network 708 can then be deployed to implement any number of machine learning operations.

In at least one embodiment, untrained neural network 706 is trained using unsupervised learning, wherein untrained neural network 706 attempts to train itself using unlabeled data. In at least one embodiment, unsupervised learning training dataset 702 will include input data without any associated output data or “ground truth” data. In at least one embodiment, untrained neural network 706 can learn groupings within training dataset 702 and can determine how individual inputs are related to untrained dataset 702. In at least one embodiment, unsupervised training can be used to generate a self-organizing map, which is a type of trained neural network 708 capable of performing operations useful in reducing dimensionality of new data 712. In at least one embodiment, unsupervised training can also be used to perform anomaly detection, which allows identification of data points in a new dataset 712 that deviate from normal patterns of new dataset 712.

In at least one embodiment, semi-supervised learning may be used, which is a technique in which in training dataset 702 includes a mix of labeled and unlabeled data. In at least one embodiment, training framework 704 may be used to perform incremental learning, such as through transferred learning techniques. In at least one embodiment, incremental learning enables trained neural network 708 to adapt to new data 712 without forgetting knowledge instilled within network during initial training.

### Data Center

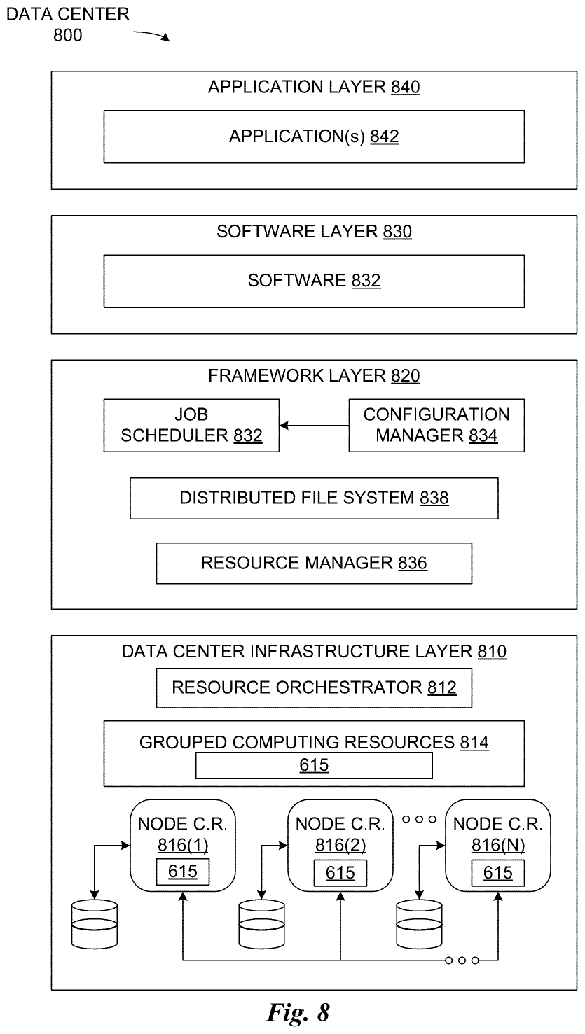

FIG. 8 illustrates an example data center 800, in which at least one embodiment may be used. In at least one embodiment, data center 800 includes a data center infrastructure layer 810, a framework layer 820, a software layer 830 and an application layer 840.

In at least one embodiment, as shown in FIG. 8, data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 816(1)-816(N) may be a server having one or more of above-mentioned computing resources.

In at least one embodiment, grouped computing resources 814 may include separate groupings of node C.R.s housed within one or more racks (not shown), or many racks housed in data centers at various geographical locations (also not shown). Separate groupings of node C.R.s within grouped computing resources 814 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 822 may configure or otherwise control one or more node C.R.s 816(1)-816(N) and/or grouped computing resources 814. In at least one embodiment, resource orchestrator 822 may include a software design infrastructure (“SDI”) management entity for data center 800. In at least one embodiment, resource orchestrator may include hardware, software or some combination thereof.

In at least one embodiment, as shown in FIG. 8, framework layer 820 includes a job scheduler 832, a configuration manager 834, a resource manager 836 and a distributed file system 838. In at least one embodiment, framework layer 820 may include a framework to support software 832 of software layer 830 and/or one or more application(s) 842 of application layer 840. In at least one embodiment, software 832 or application(s) 842 may respectively include web-based service software or applications, such as those provided by Amazon Web Services, Google Cloud and Microsoft Azure. In at least one embodiment, framework layer 820 may be, but is not limited to, a type of free and open-source software web application framework such as Apache Spark™ (hereinafter “Spark”) that may utilize distributed file system 838 for large-scale data processing (e.g., “big data”). In at least one embodiment, job scheduler 832 may include a Spark driver to facilitate scheduling of workloads supported by various layers of data center 800. In at least one embodiment, configuration manager 834 may be capable of configuring different layers such as software layer 830 and framework layer 820 including Spark and distributed file system 838 for supporting large-scale data processing. In at least one embodiment, resource manager 836 may be capable of managing clustered or grouped computing resources mapped to or allocated for support of distributed file system 838 and job scheduler 832. In at least one embodiment, clustered or grouped computing resources may include grouped computing resource 814 at data center infrastructure layer 810. In at least one embodiment, resource manager 836 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 838 of framework layer 820. one or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 838 of framework layer 820. one or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 834, resource manager 836, and resource orchestrator 812 may implement any number and type of self-modifying actions based on any amount and type of data acquired in any technically feasible fashion. In at least one embodiment, self-modifying actions may relieve a data center operator of data center 800 from making possibly bad configuration decisions and possibly avoiding underutilized and/or poor performing portions of a data center.

In at least one embodiment, data center 800 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 800. In at least one embodiment, trained machine learning models corresponding to one or more neural networks may be used to infer or predict information using resources described above with respect to data center 800 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 615 are used to perform inferencing and/or training operations associated with one or more embodiments. In at least one embodiment, inference and/or training logic 615 may be used in system FIG. 8 for inferencing or predicting operations based, at least in part, on weight parameters calculated using neural network training operations, neural network functions and/or architectures, or neural network use cases described herein.

As described herein with reference to FIGS. 1-5, a method, computer readable medium, and system are disclosed for providing landmark detection using an iterative neural network. The iterative neural network may be stored (partially or wholly) in one or both of data storage 601 and 605 in inference and/or training logic 615 as depicted in FIGS. 6A and 6B. Training and deployment of the iterative neural network may be performed as depicted in FIG. 7 and described herein. Distribution of the iterative neural network may be performed using one or more servers in a data center 800 as depicted in FIG. 8 and described herein.

What is claimed is:

1. A method, comprising:
at a device:
processing an input, using an iterative neural network, to predict one or more landmarks for the input; and
outputting the one or more landmarks.

2. The method of claim 1, wherein the input is an image.

3. The method of claim 1, wherein the input is a video.

4. The method of claim 1, wherein the input depicts an image of an object.

5. The method of claim 1, wherein the one or more landmarks include landmarks located on an object.

6. The method of claim 1, wherein the iterative neural network is a deep equilibrium model (DEQ).

7. The method of claim 1, wherein the iterative neural network is trained on labeled still images.

8. The method of claim 7, wherein the input is a video having a plurality of frames, and wherein the one or more landmarks are predicted for each frame of the plurality of frames.

9. The method of claim 1, wherein a plurality of videos are labeled, and wherein each of the videos is labeled by:
utilizing a plurality of existing trained neural networks to independently predict labels for the video, and
labeling the video based on statistics of the predicted labels.

10. The method of claim 9, wherein the statistics include a mean of the predicted labels from plurality of existing trained neural networks, wherein the plurality of existing trained neural networks have been trained on still images or on videos.

11. The method of claim 1, wherein the iterative neural network predicts each of the one or more landmarks via a corresponding heatmap.

12. The method of claim 11, wherein the heatmap is converted into a landmark point representing the corresponding landmark.

13. The method of claim 1, wherein the iterative neural network processes the input over a plurality of iterations.

14. The method of claim 13, wherein an initial iteration generates at least one initial heatmap for the input, and wherein each subsequent iteration updates each heatmap from a prior iteration.

15. The method of claim 13, wherein each initial heatmap corresponds to a landmark to be learned.

16. The method of claim 13, wherein the iterative neural network processes the input over the plurality of iterations until an equilibrium is found.

17. The method of claim 1, wherein the iterative neural network includes a recurrent loss term.

18. The method of claim 1, wherein the input includes a video with a plurality of frames, and wherein the iterative neural network processes the plurality of frames to predict the one or more landmarks for each frame of the plurality of frames, including:
for each frame after an initial frame of the video, further processing, by the iterative neural network, a landmark prediction made by the iterative neural network for a prior frame of the video, to predict the one or more landmarks for the frame.

19. The method of claim 18, wherein for the initial frame, the iterative neural network further processes an initialized landmark prediction to predict the one or more landmarks for the initial frame.

20. The method of claim 19, wherein the initialized landmark prediction generated for the initial frame of the video is set to zero.

21. The method of claim 18, wherein processing the landmark prediction made by the iterative neural network for the prior frame of the video when processing a current frame of the video provides temporal coherence of predicted landmarks across sequential frames of the video.

22. The method of claim 18, wherein for each frame after the initial frame of the video, a number of steps the iterative neural network takes when processing the frame is limited based on a predefined criterion.

23. The method of claim 22, wherein the predefined criterion includes a threshold difference between outputs of sequential steps.

24. The method of claim 1, wherein the one or more landmarks predicted for the input is output to a downstream task.

25. The method of claim 24, wherein the downstream task includes a self-driving application.

26. The method of claim 25, wherein the input depicts a human face of a driver of an automobile, and wherein the self-driving application uses the one or more landmarks predicted for the human face to monitor a state of the driver of the automobile for making autonomous driving policy decisions based thereon.

27. The method of claim 24, wherein the downstream task includes an avatar-based application.

28. The method of claim 27, wherein the input depicts a human face, and wherein the avatar-based application uses the one or more landmarks predicted for the human face to apply a select avatar to the depiction of the human face.

29. The method of claim 27, wherein the input depicts a human body, and wherein the avatar-based application uses the one or more landmarks predicted for the human body to determine a pose of the human body and to generate the avatar in the pose.

30. A system, comprising:
a non-transitory memory storage comprising instructions; and
one or more processors in communication with the memory, wherein the one or more processors execute the instructions to:
process an input, using an iterative neural network, to predict one or more landmarks for the input; and
output the one or more landmarks.

31. A non-transitory computer-readable media storing computer instructions which when executed by one or more processors of a device cause the device to:
process an input, using an iterative neural network, to predict one or more landmarks for the input; and
output the one or more landmarks.
